(19) United States
(12) Patent Application Publication
(10) Pub. No.: US 2006/0026244 A1
(43) Pub. Date: Feb. 2, 2006

(54) Electronic mail system having a recipient field modifier function

(75) Inventor: Keith S. Watson, Spencerport, NY (US)

Correspondence Address: Paul J. Maginot;MAGINOT, MOORE & BECK LLP, Bank One Center/Tower, Suite 300, 111 Monument Circle, Indianapolis, IN, 46204-5115, US

(73) Assignee: Xerox Corporation

(21) Appl. No.: 10/903,435

(22) Filed: Jul. 30, 2004

(51) Int. Cl. G06F 15/16

(52) U.S. Cl. 709/206

(57) ABSTRACT

A method, system and graphic user interface for modifying a recipient field label associated with a recipient of an e-mail message are disclosed. A recipient field label modifier function is provided that operates to modify the recipient field label associated with a selected recipient. An object associated with the modifier function is provided on a screen including a list of e-mail recipients. Selection of the object associated with the modifier function causes objects to be displayed for modifying the recipient field label associated with a selected recipient to any available type of recipient field label.

### BACKGROUND AND SUMMARY

The present invention relates to electronic mail and more particularly to updating distribution lists for electronic mail.

Recently, there has been an increased reliance on electronic mail (“e-mail”) exchanged via networks as a means of communication. E-mail messages typically contain a set of fields forming a header followed by the text of the message itself. When transmitting an electronic mail to many recipients, the electronic mail address of the recipient, is listed in the address field, CC (carbon copy) field, BBC (blind carbon copy) field or the like. When transmitting the electronic mail by listing the recipients in such a manner, the electronic mail having the same message content is received by each recipient.

However, by convention, much of which is borrowed from standard written mail protocol, certain fields are utilized for certain purposes. For instance, the address field is typically utilized to list the name or names of the person or persons to whom information in the electronic mail is of critical importance. Typically, the body of the electronic mail may contain a salutation or reference to the individuals in the address field by name or request an action or response from such individuals. Persons listed in the carbon copy field are typically persons who have an interest in the subject matter of the body of the e-mail whose identity is not intended to be concealed from the persons listed in the address field. Under normal circumstances, persons listed in the carbon copy field are not expected to act upon the body of the e-mail or return a response thereto. Persons listed in the blind copy field are typically persons who have an interest in the subject matter of the e-mail but whose identity is desired to be protected from, or whose receipt of the e-mail is preferred not to be disclosed to, the persons listed in the other fields.

Typically, e-mail composing devices, hereinafter also referred to as e-mail editors, provide a form window having several frames that are to be filled in during composition of the e-mail. The addressee frame, carbon copy frame and blind carbon copy frame are typically separate recipient frames that are logically filled prior to creation of the body of the e-mail message. The e-mail address (or other identification that the e-mail editor associates with the e-mail address) of the recipients are entered into the appropriate recipient frame and then the text of the e-mail is entered into the message frame. Other frames, e.g. an attachment frame, a subject frame etc., are often present within the form window. Those skilled in the art will recognize that e-mail editors typically permit information to be entered in the various frames in the form window in whatever order the sender desires by permitting the sender to select a frame in which information is to be entered by either clicking in the frame or tabbing to the frame.

While several types of E-mail servers are available, many e-mail systems utilize a version of Post Office Protocol (POP) e-mail server for receipt of incoming messages and a Simple Mail Transfer Protocol (SMTP) e-mail server for sending outgoing messages. SMTP messages include headers utilized by the SMTP server to properly direct and transmit an e-mail message. E-mail editors are configured to generate the appropriate SMTP header based on information entered into the various field frames of the form window.

However, there are many cases in which after having added the e-mail address of a recipient to one of the recipient field windows, it is determined that such recipient should more appropriately be the associated with another recipient field. For example, a recipient may originally be associated with the addressee field, but after drafting the body of the e-mail, it may be apparent that they are not addressed therein or no action is requested on their part and, thus, they should more appropriately be listed in the carbon copy field.

One common e-mail editor provided in Microsoft® Outlook personal information manager and messaging client, permits a recipient's e-mail address to be moved between recipient fields, however, such a move requires a number of steps. Typically recipient field modification requires either deletion of the address from the inappropriate field and re-entry into the appropriate field or cutting and pasting the address from the inappropriate recipient field to the appropriate recipient field. For example, if a sender originally selects the addressee field by selecting the “To:” button and enters the recipients e-mail address, or other moniker associated by the device with such address, in the “To:” recipient field and later determines that the recipient should not be an addressee but should instead receive a carbon copy, changing the recipient filed associated with the recipient includes several steps.

The following scenario illustrates the number of steps required to change the recipient field label associated with a recipient in Microsoft® Outlook from the addressee To: field to the carbon copy Cc: field:
1. Click the To: button;
2. Search for a recipient's name within a phonebook;
3. Add the recipient's name to the To: list;
4. Click O.K.;
5. Select the recipient's name within the To: list;
6. Select “Delete” or “Cut”; and,
7. Either
   a. Select the Cc: button and paste the entry if the recipient's name was cut in step 6, or
   b. Repeat steps 2-4 if the recipient's name was deleted in step 6.

Many programs do not prohibit the entry of a recipient's address in more than one recipient field. Common courtesy aside, there are disadvantages to a recipient receiving multiple copies of the same e-mail. For example, especially when there is a large attachment to the e-mail, a long period of time is taken for the communication which slows the operation of the sender's and recipient's computer. Also, communication expenses increase when multiple copies of an e-mail are sent to the same recipient and additional memory is utilized in the recipient's computer for saving the redundant e-mails. Moreover, the sender of the electronic mail is causing inconvenience to the recipient of multiple e-mail copies.

Thus, e-mail users would appreciate an e-mail editor that facilitates rapid movement of a recipient's address between recipient field frames. Additionally, e-mail users would appreciate an e-mail editor that inhibits a recipient being listed in more than one recipient field on the same e-mail.

The present invention facilitates rapid alterations of the recipient fields of an e-mail form window in an e-mail editor. The disclosed device reduces the likelihood of sending multiple copies of the same e-mail to the same recipient.

According to one aspect of the invention, a method of sending e-mail message comprises the steps of identifying a recipient having a type of recipient field label associated therewith, determining whether the recipient field label associated with the recipient should be modified to a different type of recipient field label, providing a function to modify the type of recipient field label associated with a recipient, selecting a recipient having a type of recipient field label associated therewith that has been determined should be modified and executing the function to modify the type of recipient field label associated with the selected recipient. The type of recipient field label indicates that the recipient will receive the e-mail as an addressee or will receive a carbon copy of the e-mail. The provided function generates a selectable list of types of recipient field labels and operates to modify the recipient field label associated with a selected recipient to the type selected from the list. The executing the function step includes selecting a type of recipient field label from the selectable list generated by the function.

According to another aspect of the invention, graphic user interface is provided having a function for composing an e-mail, a function for selecting a recipient, a function for modifying the type of recipient field label associated with the selected recipient and a function for sending the e-mail message to the each recipient in accordance with the recipient field label associated with the recipient. The composed e-mail message includes at least one recipient associated with a type of recipient field label selected from available types of recipient field labels. The available types of recipient field labels include an addressee recipient field label and a carbon copy recipient field label. The function for selecting a recipient designates a selected recipient.

According to yet another aspect of the invention, a system that sends an electronic mail message to e-mail recipients each of which has a type of recipient field label associated therewith in accordance with the type of recipient field label associated with each of the plurality of e-mail recipients is provided. The system comprises a processing circuit, a display manager and a communication manager. The processing circuit associates a recipient field label with each e-mail recipient corresponding to a recipient field selected from the group of recipient fields including an addressee recipient field, a carbon copy recipient field and a blind carbon copy recipient field. The display manager displays a first graphical user interface screen including a list of e-mail recipients and the recipient field label associated with each e-mail recipient and an option that allows a user to modify the recipient field label associated with a selected e-mail recipient displayed in the list. The communication manager sends the e-mail message to each e-mail recipient in accordance with the recipient's associated recipient field label. The display manager displays a second graphical user interface upon selection of a recipient from the list of e-mail recipients and selection of the option. The second graphical user interface screen comprises a selectable object associated with a function that modifies the recipient field label associated with the selected recipient to the addressee recipient field, a selectable object associated with a function that modifies the recipient field label associated with the selected recipient to the carbon copy recipient field, and a selectable object associated with a function that modifies the recipient field label associated with the selected recipient to the blind carbon copy recipient field.

Additional features and advantages of the present invention will become apparent to those skilled in the art upon consideration of the following detailed description of preferred embodiments exemplifying the best mode of carrying out the invention as presently perceived.

### BRIEF DESCRIPTION OF THE DRAWINGS

For a more complete understanding of the present invention and for further advantages thereof, reference is now made to the following Detailed Description taken in conjunction with the accompanying drawings, in which:

FIG. 1 is a functional block diagram outlining a first exemplary embodiment of an e-mail system according to this invention;

FIG. 2 is a schematic representation of an upper level e-mail graphical user interface screen for selecting recipients to receive an e-mail message according to this invention showing a recipient being selected whose recipient field is to be modified;

FIG. 3 is a schematic representation of the upper level e-mail graphical user interface screen of FIG. 2 showing a Details button being selected for a highlighted recipient whose recipient field is to be modified;

FIG. 4 is a schematic representation of a details graphical user interface screen providing information regarding the highlighted recipient of FIG. 2 and indicating that the highlighted recipient's current recipient field is “To:” and showing the cursor positioned to change the recipient field for the highlighted recipient to “Bcc:”;

FIG. 5 is a schematic representation of the details graphical user interface screen of FIG. 4 indicating that the highlighted recipient's current recipient field has been changed “Bcc:” and showing the cursor positioned to save the change in the recipient field;

FIG. 6 is a schematic representation of the upper level e-mail graphical user interface screen indicating that the recipient field of the recipient highlighted in FIG. 2 has been modified to “Bcc:”; and,

FIGS. 7A and 7B are a flow chart showing a method of sending an e-mail including a recipient field modifier function.

Corresponding reference characters indicate corresponding parts throughout the several views. Like reference characters tend to indicate like parts throughout the several views.

### DETAILED DESCRIPTION

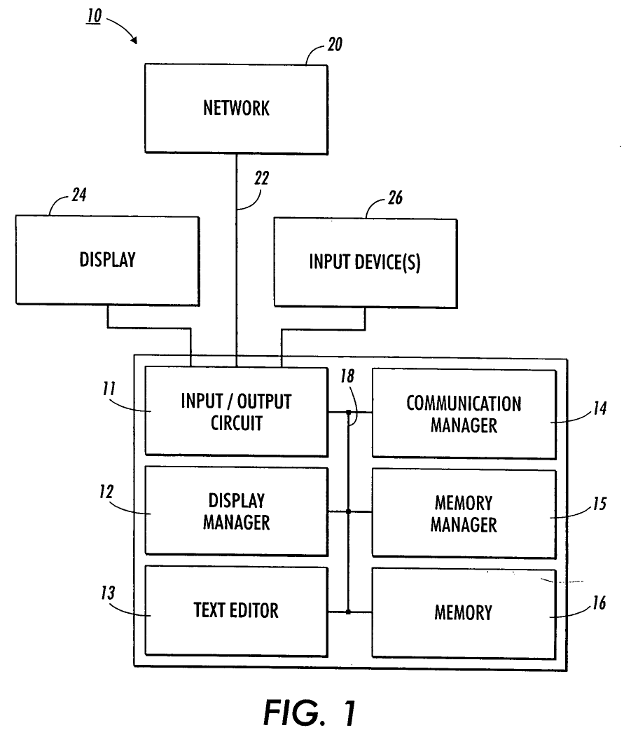

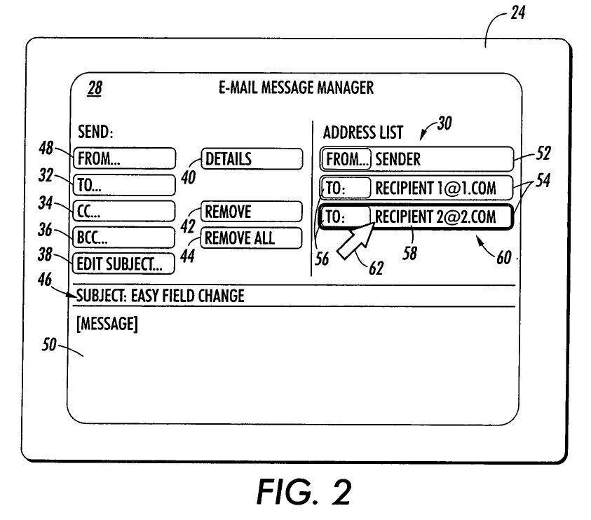

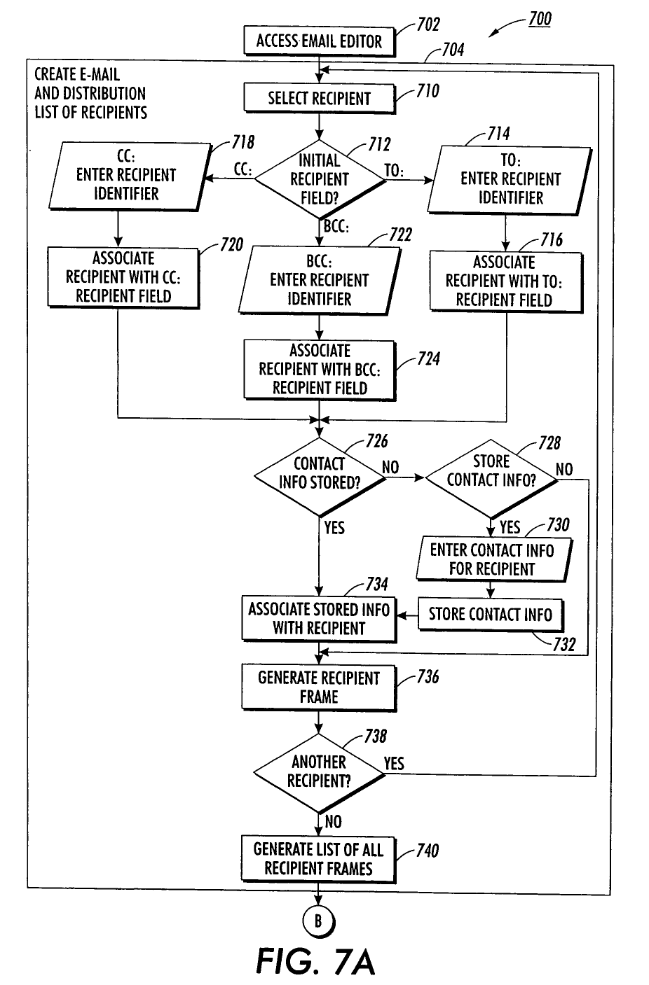

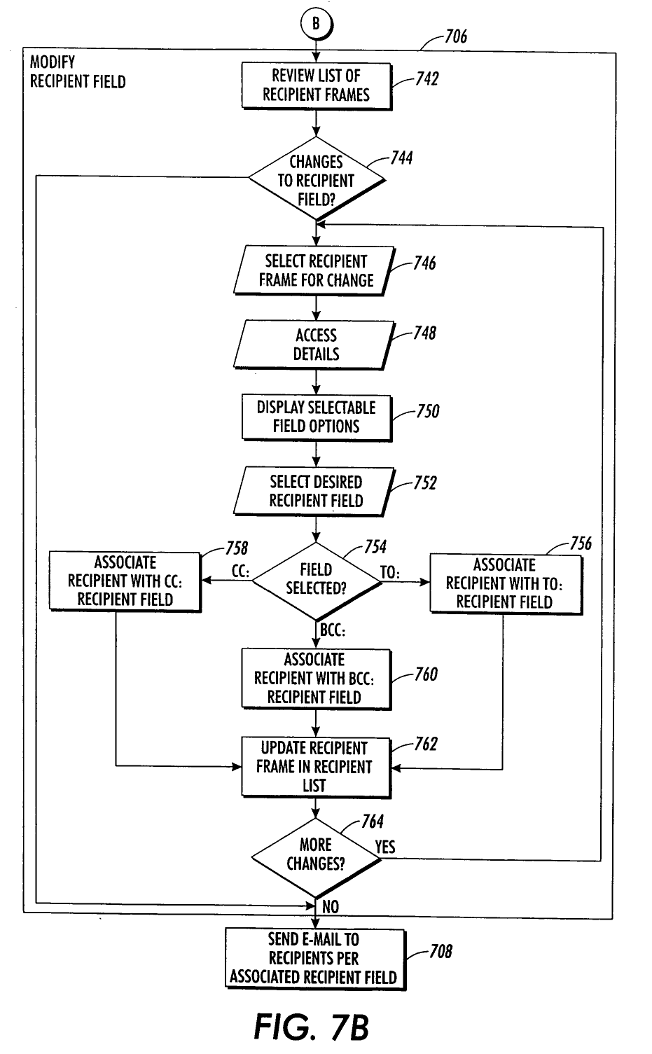

For simplicity and clarification, the operating principles, design factors, and layout of the e-mail systems, methods, and graphical user interfaces according to this invention are explained with reference to an exemplary embodiment of an e-mail system 10, shown in FIG. 1, graphical user interface shown in FIGS. 2-6 and an exemplary embodiment of a method 700 for sending a message shown in FIGS. 7A and 7B. The basic explanation of the operation of the e-mail systems, methods, and graphical user interface is applicable for the understanding and design of the constituent components employed in the e-mail systems, methods, and graphical user interfaces of this invention.

Additionally, in the various exemplary embodiments described herein, for example, the e-mail system 10 is described with respect to a user sending a new e-mail message to multiple recipients. Alternatively, the e-mail systems, methods and graphical user interfaces of this invention also operate when a user sends a new e-mail to a single recipient or forwards an e-mail message to a single or multiple recipients.

FIG. 1 is a functional block diagram outlining a simplified exemplary embodiment of the e-mail system 10 having an e-mail recipient field modifier function, according to this invention. As shown in FIG. 1, an e-mail system 10 includes at least some of an input/output circuit 11, a display manager 12, a text editor 13, a communication manager 14, a memory manager 15, and a memory 16, connected together by a data/control bus 18. In various exemplary embodiments, the e-mail system 10 will be included as part of the software executing on a computer or on a personal digital assistant (PDA). It should be appreciated that any other known or later developed system capable of processing and outputting data could be used in place of the computer or PDA.

As shown in FIG. 1, the memory 16 can be implemented using any appropriate combination of alterable, volatile or non-volatile memory or non-alterable, or fixed, memory. The alterable memory, whether volatile or non-volatile, can be implemented using any one or more of static or dynamic RAM, a floppy disk and disk drive, a writable or re-rewriteable optical disk and disk drive, a hard drive, flash memory or the like. Similarly, the non-alterable or fixed memory can be implemented using any one or more of ROM, PROM, EPROM, EEPROM, an optical ROM disk, such as a CD-ROM or DVD-ROM disk, and disk drive or the like.

The input/output circuit 11 is connected to one or more of a display 24, one or more input devices 26, and, over a link 22, to a network 20. In various exemplary embodiments, the display 24 can be a cathode ray tube display, a liquid crystal display or any other known or later developed system capable of displaying data. The one or more input devices 26 can be one or more of a keyboard, a mouse, a touch screen, a touch pad, a microphone or any other known or later developed device capable of inputting data. The input/output circuit 11 receives data from each of the one or more input devices 26, over the link 22, from the network 20, and transmits the received data to the data/control bus 18. The input/output circuit 11 also receives data from the data/control bus 18 and transmits that data to at least one of the display 24, the one or more input devices 26, and over the link 22 to the network 20.

The link 22 can be any known or later developed device or system for connecting the e-mail system 10 to the network 20, including a direct wired connection, a connection over the public switched telephone network, a connection over a coaxial cable (i.e., CATV) system, a connection over a cellular telephone network, a satellite connection or the like. In general, the link 22 can be any known or later developed connection system or structure usable to connect the e-mail system 10 to the network 20, including both wired and wireless connections.

The display manager 12 drives the display 24. The text editor 13 allows the user to compose and edit e-mail messages. The memory 16 stores e-mail messages composed using the text editor 13. The memory manager 15 manages reading data from and writing data to the memory 16. The memory 16 stores software and data used by the e-mail system 10. For example, the memory 16 stores word processing software and communication software. The communication manager 14 drives the transmission of data to and the reception of data from the network 20 through the link 22.

In operation, one exemplary embodiment of the e-mail system 10, the e-mail system 10 is in a normal mode in which the user can utilize all the e-mail functions that the e-mail system 10 is able to perform. The display manager 12 generates an upper level graphical user interface screen 28, as shown, for example, in FIGS. 2, 3 and 6, that is presented on the display 24 to facilitate user interaction with the text editor 13 and communication manager 14 of the e-mail system 10. The illustrated upper level graphical user interface screen 28 includes an “Address List” frame 30, an addressee “To . . . ” button 32, a carbon copy “Cc: . . . ” button 34, a blind carbon copy “Bcc . . . ” button 36, an “Edit Subject . . . ” button 38, a “Details” button 40, a “Remove” button 42, a “Remove All” button 44, a subject bar 46, a sender “From . . . ” button 48 and a text box 50. In the illustrated embodiment, the Address List frame 30 includes a sender frame 52 and one or more selectable recipient frames 54. Each selectable recipient frame 54 includes a recipient type icon 56 and a recipient identifier 58. In the illustrated embodiment, there is a separate recipient type icon 56 for each type of e-mail recipient, i.e. “To:”, “Cc:” and “Bcc:”. The recipient identifier 58, may be the e-mail address of a recipient or some other identifier associated with the recipient's e-mail address.

The addressee “To . . . ” button 32, the carbon copy “Cc: . . . ” button 34 and the blind carbon copy “Bcc: . . . ” button 36 are each objects having a function operating on the Address List frame 30. When the addressee “To: . . . ” button 32 is actuated, a function is initialized permitting a selectable recipient frame 54 to be added to the Address List frame 30 designated as an addressee by the recipient type icon 56. When the carbon copy “Cc: . . . ” button 34 is actuated, a function is initialized permitting a selectable recipient frame 54 to be added to the Address List frame 30 designated as a carbon copy recipient by the recipient type icon 56. When the blind carbon copy “Bcc: . . . button 36 is actuated, a function is initialized permitting a selectable recipient frame 54 to be added to the Address List frame 30 designated as a blind carbon copy recipient by the recipient type icon 56. The addressee “To: . . . ” button 32, carbon copy “Cc: . . . button 34 and blind carbon copy “Bcc: . . . ” button 36 are utilized during the creation of the e-mail and original distribution list for the e-mail.

After actuation of the addressee “To . . . ” button 32, the carbon copy “Cc: . . . button 34 and the blind carbon copy “Bcc: . . . ” button 36, one or more recipients may be designated to receive the e-mail message using input from either the memory 16 (which illustratively stores an address book containing contact information for possible e-mail recipients) or the text editor 13 by adding recipient identity information using the input device 26 to the recipient identifier 58 of the generated recipient frame 54. Once a recipient has been designated to receive the e-mail, the e-mail system 10 generates the selectable recipient frame 54 in the Address List frame 30 including the appropriate recipient type icon 56 and the recipient identifier 58.

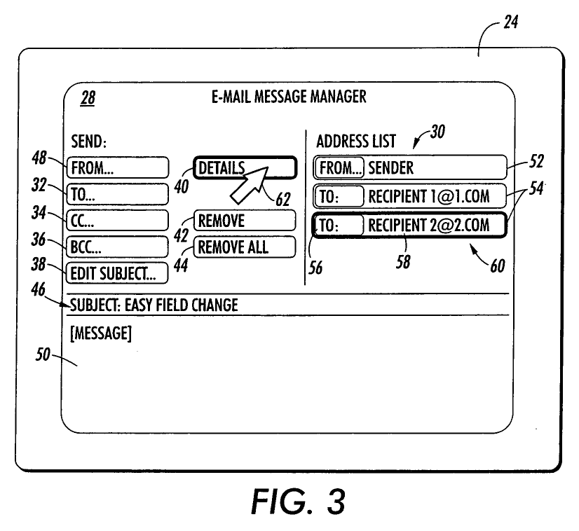

The Details button 40, Remove button 42 and Remove All button 44 are objects that interface with the sender frame 52 and the selectable recipient frames 54 in the Address List frame 30. When the sender frame 52 or one of the selectable recipient frames 54 in the Address List frame 30 have been selected or highlighted, as shown for example, in FIGS. 2 and 3, selection of the Remove button 42 or Details button 40 causes the function associated with that object to operate on the selected or highlighted frame 60 of the Address List frame 30. In the described embodiment, the selectable recipient frames 54 and sender frame 52 may be selected in a variety of ways, including, but not limited to, placing the cursor 62 on frame and clicking or tabbing to the frame. When a frame of the Address List frame 30 is selected or highlighted and the Remove button 42 is selected, the sender frame 52 or recipient frame 54 which is the highlighted frame 60 is removed from the Address List frame 30. When a frame 52, 54 of the Address List frame 30 is selected or highlighted and the Remove All button 44 is selected, all of the senders and/or recipient frames, 52 and 54, respectively are removed from the Address List frame 30. The Details button 40 is an object associated with a function that generates a details graphical user interface screen 64 for the selected or highlighted sender frame 52 or selectable recipient frame 54 of the Address List frame 30 as more fully explained below.

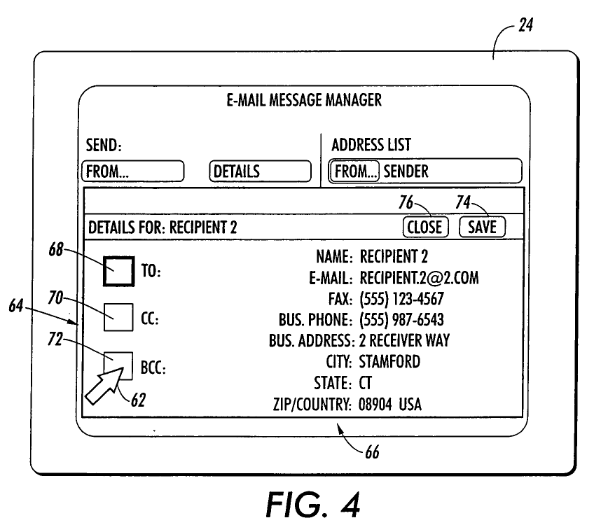

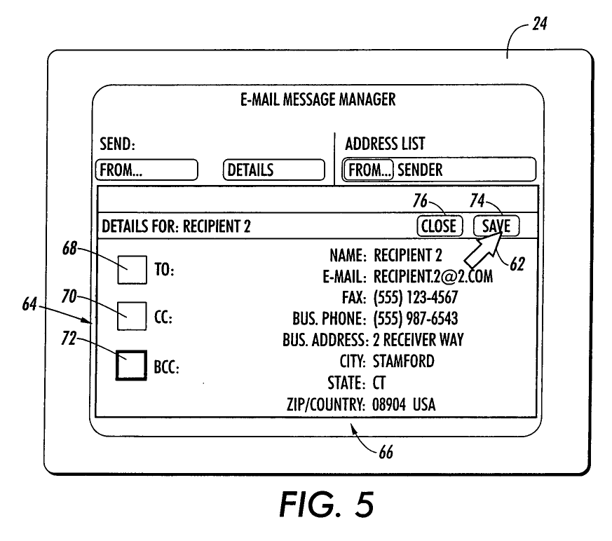

When the Details button 40 is actuated and a sender frame 52 or selectable recipient frame 54 has been highlighted, the e-mail system 10 drives the display 24 to display a details graphical user interface screen 64 for the selected frame 60, as shown, for example, in FIGS. 4 and 5. The details graphical user interface screen 64 displays contact information 66 regarding the recipient of the highlighted frame 60, a To: radio button 68, a Cc: radio button 70, a Bcc: radio button 72, a save button 74 and a close button 76.

The provided details graphical user interface screen 64 permits the sender to easily update the distribution e-mail label or address list 30 by moving a recipient's e-mail address between the addressee (To:) field, the carbon copy (Cc:) field and the blind carbon copy (Bcc:) field without deleting and re-entering the recipient's e-mail address. The updating task is accomplished by providing the user with the details graphical user interface screen 64 accessible from the upper level graphical user interface screen 28 of the e-mail editor that includes three mutually exclusive buttons 68, 70, 72 (one for each distribution e-mail label). In addition to the three buttons 68, 70, 72, the details graphical user interface screen 64 includes all attributes of the recipient that are stored within the address book (e.g. friendly name, e-mail address, regular mail address, phone numbers etc.) as contact information 66. The contact information 66 allows the user to confirm that the correct recipient was added, and verify that the correct recipient field label was assigned to the recipient.

The user changes the recipient field label associated with the selected recipient by selecting the radio button 68, 70, 72 corresponding to the desired e-mail recipient field label. Each radio button 68, 70, 72 is an object with a function associated therewith that interfaces with the recipient type icon 56 and with the recipient field label associated with the recipient selected prior to entering the details graphical user interface screen 64. The function associated with each radio button 68, 70, 72 operates only if the save button 74 is selected to initiate a return from the details graphical user interface screen 64 to the upper level graphical user interface screen 28. If the close button 76 is selected to initiate a return from the details graphical user interface screen 64 to the upper level graphical user interface screen 28, the recipient type icon 56 and the recipient field label associated with the recipient frame 54 selected prior to entering the details graphical user interface screen 64 is not affected upon return to the upper level graphical user interface screen 28.

The embodiment illustrated in FIGS. 2-6, presupposes that a first and second recipient were originally designated as addressees (To:) of the e-mail message by the user actuating the addressee “To . . . ” button 32 and entering the first and second recipient's recipient identifier 58 information. Upon completion of this task, the function associated with the addressee “To . . . ” button 32 generated two selectable recipient frames 54 in the Address list frame 30 including a To: recipient type icon 56 and the recipient identifier 58 associated with the first and second recipients, respectively. The function associated with the addressee “To: . . . ” button 32 also generated an initial To: recipient field label to be associated with the first and second recipient at the time of sending of the e-mail message.

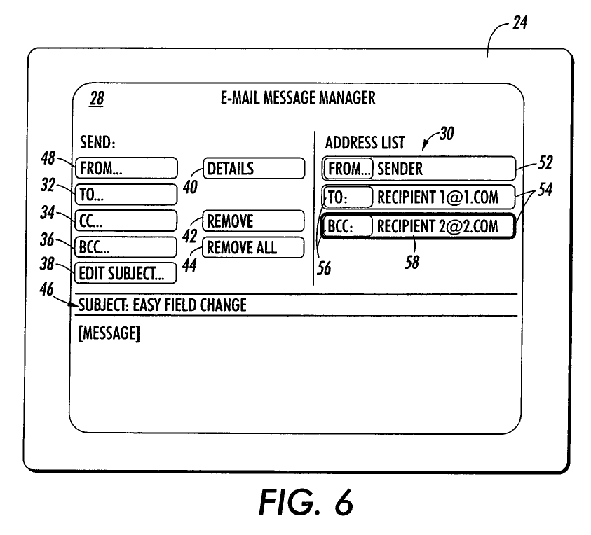

In the illustrated embodiment, the user modifies the recipient field associated with the second recipient from an addressee recipient field to a blind carbon copy field. The user selects the second recipient of the e-mail message, having an e-mail address recipient2@2.com, from the address list 30 by placing the cursor 62 on the selectable recipient frame 54 containing the second recipient's recipient identifier 58 and clicking (FIG. 2). The user then places the cursor 62 over the Details button 40 and clicks to generate the details graphical user interface screen 64 containing contact information 66 (previously entered) regarding the second recipient. Initially, the details graphical user interface screen 64 displays a shaded To: radio button 68 indicating that the second recipient was originally, or currently is, designated as an addressee of the e-mail message (FIG. 4). The user then places the cursor 62 over the radio button corresponding to the desired recipient field label, illustratively the Bcc: radio button 72, to be associated with the second recipient and clicks. The details graphical user interface screen 64 then unshades the To: radio button 68 and shades the Bcc: radio button 72 indicating that recipient field associated with the second recipient will be changed to Bcc: if the save button 74 is clicked prior to returning to the upper level graphical user interface screen 28. As shown, in FIG. 5, the user places the cursor 62 over the save button 74 and clicks to return to the upper level graphical user interface screen 28. Upon clicking the save button 74 the function associated with the Bcc: radio button 72 interacts with the recipient type icon 56 and the recipient field associated with the second recipient to generate a Bcc: recipient type icon 56 and change the recipient field associated with the second recipient to Bcc:. The address list 30 of the upper level graphical user interface screen 28 reflects these saved changes in FIG. 6. As shown in FIG. 6, the recipient frame 54 associated with the second recipient contains a Bcc: recipient type icon 56 and the recipient identifier 58 associated with the second recipient. Those skilled in the art will recognize that the upper level graphical user interface screen 28 would have been identical to that shown in FIG. 2 had the user selected the Close button 76 upon exiting the details graphical user interface screen 64.

The following scenario illustrates the number of required steps to change a distribution e-mail label of a recipient within the illustrated e-mail service 10. After the recipient has been added to the address list, by entering the recipients e-mail address and associating it with one of the recipient fields, the recipient's e-mail address can be moved to any other recipient field by performing the following four steps. First, the user selects the recipient frame 54 for the recipient from the address list 30. Second, the user selects the Details button 40 to display the details graphical user interface screen 64. Third, the user selects one of the three mutually exclusive buttons (To:, Cc:, Bcc:) 68, 70 and 72, respectively. Fourth, the user selects the save button 74 in the details graphical user interface screen 64. The recipient is then automatically grouped with the correct recipient field label and given the appropriate recipient type icon 56 in the recipient frame 54 within Address List 30 when the display returns to the upper level graphical user interface screen 28.

In one exemplary embodiment of a method 700 for using the e-mail system 10 having the e-mail recipient field modifier function, as shown, for example, in FIGS. 7A and 7B, the user accesses the e-mail editor 702, creates an e-mail and initial distribution list of recipients 704, modifies the recipient field label 706 for each recipient that needs modification and sends the e-mail to the recipients in accordance with their associated recipient field label 708. The step 704 of creating the e-mail and distribution list of recipients includes the step of generating the text of the body of the e-mail message (not separately shown but encompassed in step 704) and the several steps for adding recipients to a distribution list, as detailed, for example, in FIG. 7A. The generating the text of the body of the e-mail message step is not separately shown as it may be performed at anytime prior to sending the e-mail.

Recipients are added to the distribution list by selecting a recipient 710 for the e-mail and making an initial determination of the recipient field label to be associated with the recipient 712. If it is initially determined that the recipient should be an addressee (To:), then the user enters a recipient identifier associated with the recipient 714 and associates the recipient with the addressee “To:” field label 716. If the upper level graphical user interface screen 28 is utilized to carry out these steps, the user selects the addressee “To: . . . ” button 32 and enters the recipient identifier 58 in a text box generated by the function associated with the addressee button 32. After entry of the recipient identifier 58, the function associated with the addressee button 32 associates the recipient with the addressee (To:) recipient field label and generates a To: recipient type icon 56 to be displayed in the recipient frame 54 displaying the recipient identifier 58. Those skilled in the art will recognize that other graphical user interfaces and other forms of an e-mail editor could be utilized to facilitate entry of the recipient identifier 714 and association of the recipient with the addressee (To:) recipient field label 716.

If it is initially determined that the recipient should receive a carbon copy (Cc:) of the e-mail, then the user enters a recipient identifier associated with the recipient 718 and associates the recipient with the carbon copy “Cc:” field label 720. If the upper level graphical user interface screen 28 is utilized to carry out these steps, the user selects the carbon copy “Cc: . . . ” button 34 and enters the recipient identifier 58 in a text box generated by the function associated with the carbon copy button 34. After entry of the recipient identifier 58, the function associated with the carbon copy button 34 associates the recipient with the carbon copy “Cc:” recipient field label and generates a Cc: recipient type icon 56 to be displayed in the recipient frame 54 displaying the recipient identifier 58. Those skilled in the art will recognize that other graphical user interfaces and other forms of an e-mail editor could be utilized to facilitate entry of the recipient identifier 718 and association of the recipient with the carbon copy “Cc:” recipient field label 720.

If it is initially determined that the recipient should receive a blind carbon copy (Bcc:) of the e-mail, then the user enters a recipient identifier associated with the recipient 722 and associates the recipient with the blind carbon copy “Bcc:” field label 724. If the upper level graphical user interface screen 28 is utilized to carry out these steps, the user selects the blind carbon copy “Bcc: . . . ” button 36 and enters the recipient identifier 58 in a text box generated by the function associated with the blind carbon copy button 36. After entry of the recipient identifier 58, the function associated with the blind carbon copy button 36 associates the recipient with the blind carbon copy “Bcc:” recipient field label and generates a Bcc: recipient type icon 56 to be displayed in the recipient frame 54 displaying the recipient identifier 58. Those skilled in the art will recognize that other graphical user interfaces and other forms of an e-mail editor could be utilized to facilitate entry of the recipient identifier 722 and association of the recipient with the blind carbon copy “Bcc:” recipient field label 724.

After entering a recipient identifier associated with the recipient and initially associating the recipient with an initial appropriate recipient field identifier, it is determined whether contact information is stored for the recipient 726. If contact information is stored, the stored contact information is associated with the recipient 734. If contact information is not stored for the recipient, the user may be provided with an interface permitting such information to be entered and stored. If the user determines to store contact information, the contact information is entered for the recipient 730 and the contact information is stored 732. The stored contact information is associated with the recipient 734. The implementation of an address book or contact list is well known in the art and such address book or contact list and the interfaces for generating and storing the same may be utilized within the scope of the disclosure for generation and storage of the contact information.

After associating contact information with the recipient, or if it was decided not to store contact information regarding the recipient, a recipient frame is generated 736. The recipient frame will preferably include recipient identity information associated with the recipient's e-mail address and indicia of the recipient field label associated with the recipient. If the disclosed upper level graphical user interface screen 28 is utilized, the recipient frame will be a selectable recipient frame 54 including a recipient type icon 56 and the recipient identifier 58 associated with the recipient. Other interfaces may generate recipient frames in different manners within the scope of the disclosure. Once a recipient frame has been generated for the first recipient, it is determined whether another recipient should be added to the distribution list 738. If so, control returns to step 710 and is followed through until another recipient frame is generated in step 736 for the additional recipient. This control loop may be repeated until recipient frames are generated 736 for all of the desired recipients of the e-mail.

Once it is determined that there are no other desired recipients of the e-mail, a distribution list is generated containing all of the generated recipient frames 740. Such distribution lists are often referred to as address lists and are implemented in different fashions by different e-mail editors. The disclosed e-mail system 10 generates an address list that lists each of the recipients in a recipient frame 54 in the address list frame 30 of the upper level graphical user interface screen 28, regardless of whether there is only one or more recipients of the e-mail. Other e-mail editors may generate distribution lists in different fashions, for example, separate addressee, carbon copy and blind carbon copy frames may be provided each containing the recipient identifier for each recipient associated with the recipient field label corresponding to the frame. Once the e-mail and distribution list have been created 704, control transfers to the modify recipient field step 706.

As shown, for example, in FIG. 7B, the modify recipient field step 706 includes reviewing the list of recipient frames 742 to determine if the recipient field label associated with a recipient should be changed 744. If it is determined that the recipient field label associated with one of the recipients on the list of recipients should be changed, the user selects the recipient frame that should be changed 746. If the disclosed graphical user interface including screens 28 and 64 is utilized to send the e-mail, the recipient frame to be changed is selected by selecting the recipient frame 54 in the Address list frame 30 by, for example, clicking on the frame associated with the recipient whose recipient field label should be changed to highlight the frame as a selected frame 60. Selection of a recipient frame can be accomplished in other manners within the scope of the disclosure, including tabbing to the desired recipient frame.

After the recipient frame containing the recipient whose associated recipient field requires modification, the user accesses a function for modifying the recipient field label 748. The function for modifying the recipient field label generates a display of selectable recipient field options 750, from which the user selects the desired recipient field option 752 corresponding to the desired recipient field label to be associated with the recipient whose recipient frame was selected in step 746.

In the illustrated embodiment, the types of recipient field labels that may be associated with a recipient are an addressee (To:) recipient field label, a carbon copy (Cc:) recipient field label and a blind carbon copy (Bcc:) recipient field label. The user determines which of these recipient field labels to associate with the selected recipient in step 754. If the user selects to associate the selected recipient with the addressee (To:) recipient field label, the function associated with the To: recipient field option associates the selected recipient with the addressee (To:) recipient field label 756. If the user selects to associate the selected recipient with the carbon copy (Cc:) recipient field label, the function associated with the Cc: recipient field option associates the selected recipient with the carbon copy (Cc:) recipient field label 758. If the user selects to associate the selected recipient with the blind carbon copy (Bcc:) recipient field label, the function associated with the Bcc: recipient field option associates the selected recipient with the blind carbon copy (Bcc:) recipient field label 760. The selected recipient frame is then updated in the recipient list 762 to reflect the modification of the recipient field label associated with the recipient designated therein. The user then determines if there are additional recipient frames that need to have the recipient field label associated therewith modified 764. If so, control reverts to step 746 and continues through step 762 after which the user can then decide whether to make additional changes. When no more recipient field labels associated with recipients need to be changed, the e-mail message is then sent to the recipients in the list of recipients in accordance with the recipient field label associated with each recipient 708.

If the disclosed graphical user interface is utilized to send the e-mail, after accessing the details graphical user interface screen 64, the user selects from one of the three mutually exclusive radio buttons 68, 70, 72 to modify the recipient field label associated with the selected recipient. However, as previously explained, modification of the recipient field label associated with the selected recipient does not occur until after the user confirms the recipient field label selection by selecting the save button 74.

In other exemplary embodiments of the methods for using the e-mail system according to this invention, the graphical user interface displays described herein can be replaced with, for example, one or more icons or one or more drop-down menus. By selecting the icon(s) or the appropriate command(s) in the drop-down menu(s), the user can choose to modify the recipient field label associated with a selected recipient in the distribution list, as described above. For instance, it is within the scope of the disclosure for a drop down list including radio buttons or a checklist to be generated when the recipient type icon 56 for a recipient frame 54 is selected and for those objects to be associated with a function that changes the recipient type icon 56 and the recipient field label associated with the recipient whose recipient identifier 58 is included in the recipient frame 54. Alternatively, right clicking on a recipient frame 54 could provide access, directly or indirectly through a details item in a drop down menu, to an interface containing objects that modify the recipient field label.

It should be understood that each of the elements of the e-mail system 10 shown in FIG. 1 can be implemented as portions of a suitably programmed general purpose computer. Alternatively, each of the elements of the e-mail system 10 shown in FIG. 1 can be implemented as physically distinct hardware circuits within an ASIC, or using a FPGA, a PDL, a PLA or a PAL, or using discrete logic elements or discrete circuit elements. The particular form each of the elements of the e-mail system 10 shown in FIG. 1 will take is a design choice and will be obvious and predicable to those skilled in the art.

Moreover, the e-mail system 10 can be implemented as software executing on a programmed general purpose computer, a special purpose computer, a microprocessor or the like. In this case, the e-mail system 10 can be implemented as a routine embedded in a network client, as a resource residing on a network server, or the like. The e-mail system 10 can also be implemented by physically incorporating it into a software and/or hardware system, such as the hardware or firmware systems of a personal digital assistant, a bi-directional pager, an analog or digital cellular phone or the like.

Thus, in summary, the e-mail system 10 can be implemented on a programmed general purpose computer, a special purpose computer, a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA or PAL, or the like. In general, any device, capable of implementing a finite state machine that is in turn capable of implementing the method described above and/or the graphical user interfaces shown in FIGS. 2-6, can be used to implement the e-mail system 10.

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A method of sending an e-mail message, comprising the steps of:
identifying a recipient having a type of recipient field label associated therewith, the type of recipient field label indicating that the recipient will receive the e-mail as an addressee or will receive a carbon copy of the e-mail;
determining whether the recipient field label associated with the recipient should be modified to a different type of recipient field label;
providing a function to modify the type of recipient field label associated with a recipient, the function generating a selectable list of types of recipient field labels and operating to modify the recipient field label associated with a selected recipient to the type selected from the list;
selecting a recipient having a type of recipient field label associated therewith that has been determined should be modified; and,
executing the function to modify the type of recipient field label associated with the selected recipient by selecting a type of recipient field label from the selectable list.

2. The method of claim 1, wherein the type of recipient field label indicates that the recipient will either receive the e-mail as an addressee, will receive a carbon copy of the e-mail or will receive a blind carbon copy of the e-mail.

3. The method of claim 2, wherein the function provides a selectable confirmation option for confirming a selection of a type of recipient field label from the selectable list and requires selection of the confirmation option prior to operating to modify the type of recipient field label associated with a recipient and further comprising the step of selecting the confirmation option.

4. The method of claim 3, further comprising the step of providing a selectable list of a plurality of recipients each having a type of recipient field label associated therewith.

5. The method of claim 4, further comprising the step of sending the e-mail message to each of the plurality of recipients in the selectable list in accordance with the e-mail label field associated with each recipient.

6. The method of claim 5, wherein sending the e-mail message includes sending the e-mail message using at least one of either a wired connection or a wireless connection to a network.

7. The method of claim 2 wherein the selectable list of types of recipient field labels comprises an addressee object associated with a function for associating the addressee recipient field label with the selected recipient, a carbon copy object associated with a function for associating the carbon copy recipient field label with the selected recipient and a blind carbon copy object associated with a function for associating the blind carbon copy recipient field label with the selected recipient.

8. The method of claim 8 wherein the addressee object, carbon copy object and blind carbon copy object are each mutually exclusive so that selection of one of the objects deselects all of the other objects.

9. The method of claim 8 wherein the addressee object, carbon copy object and blind carbon copy object are each radio buttons.

10. A graphic user interface, comprising:
a function for composing an e-mail message with at least one recipient associated with a type of recipient field label selected from available types of recipient field labels, the available types of recipient field labels including an addressee recipient field label and a carbon copy recipient field label;
a function for selecting a recipient to designate as a selected recipient;
a function for modifying the type of recipient field label associated with the selected recipient; and,
a function for sending the e-mail message to the each recipient in accordance with the recipient field label associated with the recipient.

11. The graphic user interface of claim 10 wherein the types of recipient field labels includes a blind carbon copy recipient field label.

12. The graphic user interface of claim 111 and further comprising a first screen containing a distribution list operated upon by the function for composing an e-mail message to provide a list of recipients of the e-mail message and indicia of the recipient field label associated with each listed recipient and permitting selection of a listed recipient and a modification object associated with the distribution list and configured to call the function for modifying the type of recipient field label associated with a selected recipient when selected.

13. The graphic user interface of claim 11 wherein the function for modifying the type of recipient field label associated with a selected recipient generates a second screen containing an addressee object associated with a function that modifies the recipient field label associated with the selected recipient to the addressee recipient field label, a carbon copy object associated with a function that modifies the recipient field label associated with the selected recipient to the carbon copy recipient field label and a blind carbon copy object associated with a function that modifies the recipient field label associated with the selected recipient to the blind carbon copy recipient field label.

14. The graphic user interface of claim 13 wherein the addressee object, carbon copy object and blind carbon copy object are each mutually exclusive so that selection of one of the objects deselects all of the other objects.

15. The graphic user interface of claim 14 wherein the addressee object, carbon copy object and blind carbon copy object are each radio buttons.

16. The graphic user interface of claim 14 wherein the second screen contains an object associated with a function for confirming a selection of a type of recipient field label from the selectable list and requires selection of the confirmation option prior to operating to modify the type of recipient field label associated with a the selected recipient.

17. A system that sends an electronic mail message to e-mail recipients each of which has a type of recipient field label associated therewith in accordance with the type of recipient field label associated with each of the plurality of e-mail recipients, the system comprising:
a processing circuit that associates a recipient field label with each e-mail recipient, the recipient field label corresponding to a recipient field selected from the group of recipient fields including an addressee recipient field, a carbon copy recipient field and a blind carbon copy recipient field;
a display manager that displays a first graphical user interface screen including a list of e-mail recipients and the recipient field label associated with each e-mail recipient and an option that allows a user to modify the recipient field label associated with a selected e-mail recipient displayed in the list; and
a communication manager that sends the e-mail message to each e-mail recipient in accordance with the recipient's associated recipient field label;
wherein the display manager displays a second graphical user interface upon selection of a recipient from the list of e-mail recipients and selection of the option, the second graphical user interface screen comprising:
a selectable object associated with a function that modifies the recipient field label associated with the selected recipient to the addressee recipient field;
a selectable object associated with a function that modifies the recipient field label associated with the selected recipient to the carbon copy recipient field; and
a selectable object associated with a function that modifies the recipient field label associated with the selected recipient to the blind carbon copy recipient field.

18. The system of claim 17, wherein the second graphical user interface screen includes a selectable icon to return to the first graphical user interface screen without the function associated with a selectable object operating to modify the recipient field label associated with the selected recipient.

19. The system of claim 17, wherein the second graphical user interface screen includes a selectable icon to return to the first graphical user interface screen and execute the function associated with a selected selectable object operating to modify the recipient field label associated with the selected recipient.

20. The system of claim 17, wherein the selectable objects of the second graphical user interface screen are mutually exclusive so that selection of one of the objects deselects all of the other objects.
